(19) United States
(12) Patent Application Publication
(10) Pub. No.: US 2006/0255914 A1
(43) Pub. Date: Nov. 16, 2006

(54) System and transmitter

(76) Inventor: Tony Westman, Herrang (SE)

Correspondence Address: YOUNG & THOMPSON, 745 SOUTH 23RD STREET, 2ND FLOOR, ARLINGTON, VA, 22202, US

(21) Appl. No.: 10/543,159

(22) PCT Filed: Jan. 21, 2004
(86) PCT No.: PCT/SE04/00067

§ 371 Date: Jun. 5, 2006

(30) Foreign Application Priority Data
Jan. 24, 2003 (SE) 0300177-3

(51) Int. Cl. G08B 5/22

(52) U.S. Cl. 340/7.1; 340/572.1; 340/10.1

(57) ABSTRACT

An improved system for an anti-theft transponder includes, besides a general paged transponder an autonomous low power transmitter device capable of transmitting a specified address code for accessing at least one anti-theft transponder which includes one receiver module operating on a designated frequency used by a general coverage paging system. The transponder of the system additionally includes several modules for the tracking of the device when activated. The anti-theft transponder of the improved system is provided with a first individual access identity intended for authorization of activation by the paging system and at least a second general access identity code used for control of a direct activation within a limited coverage of the low power transmitter. A low power transmitter can also be regularly transmitting a general access identity code for a control that the item under surveillance does not illegally leave a site where it is kept.

### TECHNICAL FIELD

The present invention relates to a system and a device, and more exactly a system of transponders and a local low power arming transmitter device for transmitting a general activation code for initiating local transponders of the transponder system to change into an active mode.

### BACKGROUND

Modern technologies offer many different methods of surveillance of, for instance, merchandize, transported goods or even vehicles. The general manner of such surveillance is that whenever the guarded item leaves a defined area an alarm will be triggered. In many cases it is also essential to be able, after such a triggered alarm to be able track the item in a way such that it may easily be recovered.

In our initial U.S. Pat. No. 6,236,836, which discloses a generalized paging system which provides a transponder system presenting a portable or mobile system for localization of movable objects, e.g. for surveillance of valuable transports and the like. The system is controllable by a radio system and control information may even be sent to the transponder for defining for instance the basic functions of a built-in marker transmitter used for localizing the object. Furthermore, the system may utilize different localization systems, for instance the well established GPS (Global Positioning System). GPS is able to with a high accuracy present the coordinates of such a transponder supplied with a GPS receiver, and coordinates obtained may be further transferred over a suitable network, e.g. a mobile telephone network like GSM, WDMA or similar systems for tracking purposes.

Today, such systems are used, for instance, for surveillance of transports of cases with money to and from banks. Generally armed suitcases are used which together with an inking device for coloring of the notes if illegally opened also contain one or several anti-theft transponders. If the suitcase is opened by force the transponder or transponders will become active, to be able to immediately find out where it was illegitimately opened. An essential part of such a surveillance and tracking system which utilizes for instance the Global Positioning Satellite System (GPS) is that a positioning of such a protected suitcase can be obtained more or less immediately as the transponder by itself will tell it position after initiation besides it also has a transmitter for direction finding. Such a system was developed and marketed under the name C-TRACK by the assignee of the present application.

A problem was found to arise when, for instance, several suitcases containing bank notes or similar valuables are transported together and some of the suitcases are lost in a robbery, some additional time will be needed to find out which suitcases were lost for identifying those to be able to start up the individual transponders belonging to those to be able to start a tracking. To obtain the correct identity, generally referred to a RIC of the transponders of those suitcases several sources may have to be contacted before the actual transponder can be activated, which will introduce an undesired time lapse before tracking can start. Thus, this is still a problem for transporters of money even if the individual suitcases with money are provided with anti-theft transponders. Thus, in a situation of being robbed there is a desire to immediately be able to initiate transponders of stolen items at the same moment as the goods is taken, even if it is not immediately opened. As a matter of fact robbers now have learnt to in short period of time transport such a protected suitcase to a place, for instance an underground site providing radio silence, where the transponder will not easily be heard and detected when the suitcase is opened, and hoping that not all of the bank-notes will be colored when breaking the suitcase open.

Therefore an object of the present invention is to also solve the above indicated problem by providing a system which makes it possible to obtain a faster initiation of such an anti-theft transponder.

### DISCLOSURE OF THE INVENTION

An improved system for an anti-theft transponder is disclosed. The new system includes, besides a general paged transponder an autonomous low power transmitter device capable of transmitting a specified address (i.e. Receiver Identification Code, RIC) for accessing at least one anti-theft transponder which comprises one receiver module operating on a designated frequency used for instance by a general coverage paging system. A transponder of the system additionally comprises a number of further modules used for the tracking of the device when activated. Anti-theft transponders of the improved system according to the present invention are generally provided with several access identities (RIC) of which a first individual access identity is intended for authorization of activation by the paging system and at least a second general access identity will be used for a direct activation by means of the autonomous low power transmitter within its limited coverage.

In a first embodiment the autonomous low power transmitter can by means of a manual activating switch initiate transmitting of a defined series of transmissions of the authorization code for the second general access identity of transponders in the anti-theft transponder system to thereby activate each transponder at this moment receiving the transmissions of the autonomous low power transmitter. The autonomous low power transmitter being provided with individual built-in power supply is further controlled by a processor for creating the necessary signaling sequences for its transmissions. This defined series of transmissions has a repetition rate during a predetermined time period after initialization in order to guarantee a proper interlacing of transmissions by a general coverage system normally controlling activation of the transponder.

In a second embodiment an autonomous low power transmitter will automatically repeatedly be transmitting at regular intervals which transmission keeps in standby the transponders within coverage of the low power transmitter. As soon as a transponder loses next expected signal from the low power transmitter it will be activated. Such an activation will be the result when an anti-theft transponder illegally is moved away from the low power transmitter coverage area.

Typical paging signaling pattern can for instance use the POCSAG code (Post Office Standardization Advisory Group code) to produce a second general access identity to the autonomous low power transmitter for control of each anti-theft transponder within the limited coverage of the autonomous low power transmitter when the autonomous low power transmitter is trigged. Other paging protocol may as well be used like the Motorola FLEX code, the NEC (D2/D3), The GOLAY Sequential Code or the METRO code (Leading character=A).

### SHORT DESCRIPTION OF THE DRAWINGS

The invention, together with further objects and advantages thereof, may best be understood by referring to the following detailed description taken together with the accompanying drawings, in which:

FIG. 1 illustrates in a block diagram an embodiment of an autonomous low power transmitter device for a system in accordance with the present invention.

### DETAILED DESCRIPTION

A preferred embodiment of the present innovative improvement of an anti-theft transponder system will be described. In the present example a system also referred to as the C-TRACK transponder system will constitute a basis of this description of the present invention. The C-TRACK utilizes a common paging system referred to as the MiniCall system, which for instance utilizes the so called POCSAG signaling protocol. However other protocols can also be used which allows at least two identity addresses, also referred to as RIC or Capcode. For instance a standard POCSAG protocol generally will support four separate RIC:s. A Philips POCSAG decoder type PCF5001H will provide such a number of different RIC:s being used in accordance with the present invention. Other possible protocols are for instance the NEC format (D2/D3), the Motorola GOLAY (GSC) Format and METRO format and the Motorola FLEX digital display format. Also the system described by the mentioned U.S. Pat. No. 6,236,836 would be able to utilize present invention without any change of hardware, but only slightly updated software.

Thus, the present invention generally does not need to change basic hardware of existing systems, but will improve such a system by means of the following inventive steps:

Each transponder of an anti-theft system is provided with at least one further global RIC or Capcode being identical for at least a group of transponders.

A special autonomous low power transmitter is formed which by means of a designated processor started by a manual switch will create and repeatedly during a pre-determined time period locally transmit the global RIC with the proper format on the frequency of the used paging system.

Using the now disclosed improved system each person, generally a security officer, being responsible for a transport of valuables provided with anti-theft transponders is provided with the autonomous low power transmitter. The small autonomous transmitter is carried such that it is easy to access for triggering of its transmission. Being subject to a robbery (or even suspecting a robbery is going to take place) the security officer just presses the activation key of the small low power transmitter device. The transmitter immediately transmits this second RIC on the actual paging frequency and which will start any transponder in the surrounding of the low power transmitter and the transponder will then also initiate a message to be sent over SMS (Short Message Service) via a mobile telephone system.

This transmission takes place during a predetermined minimum time period to make certain that the transmission does not collide with a regular transmission on the frequency by the utilized paging system. By this technique it is made certain that that the transmission will also take place in a “window” when the ordinary transmitter does not transmit.

The autonomous low power transmitter has a limited coverage area, let us say 100 meters, which means that only the transponders of suitcases in the near vicinity will be activated, i.e. the suitcases being subject for robbery.

In a preferred embodiment the software of the anti-theft transponders will treat in a special way a message having the second global RIC. In case the data transfer in some way is in error (e.g. a bit error, which the decoder by itself is not able to correct) the program portion in the positioning equipment belonging to the second RIC is still started. The program connects the GSM unit on the closest GSM base. Furthermore the transponder transmits a SMS message to a predefined GSM telephone number (e.g. to an alarm central) giving information of the event. The GSM unit will continue to be connected to the GSM network which will facilitate the transponder to be traced by means of information from the GSM network. This implies that even if more than one transponder is activated each one will be able to independently make contact to the GSM network.

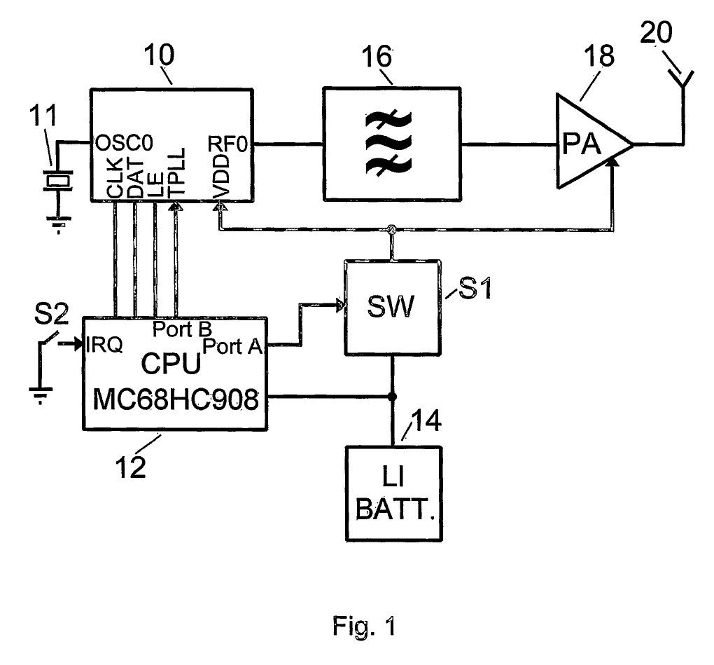

In an illustrative embodiment of the transmitter (FIG. 1) it comprises an activation switch S2, a microprocessor 12 Motorola MC68HC908 with a 4 Kbyte FLASH memory and 128 Bytes RAM, a BiCMOS transmitter circuit 10 NT2800 from NUMA Technologies, Inc., USA, a semiconductor switch S1 IRF7105, a SAW-filter 16, a VHF/UHF power circuit 18 SGA-33 from Sirenza, USA, an antenna 20 and a lithium battery 14. Typically such a setup produces approximately 20 mW on its transmit frequency.

The BiCMOS circuit 10 constitutes a Phase Locked Loop synthesizer FM modulated device delivering about 2 mW in a VHF/UHF band from 100 to 1000 MHz using a reference crystal 11 in the 24 MHz band. Furthermore it has an input for providing a tuning voltage for the internal varactor tuning diodes to thereby produce a frequency modulated output signal. A SAW-filter 16 is used to further filter the output from the circuit 10 before amplifying the FM modulated signal by a Power Amplifier 18 connected to an built-in antenna in the autonomous low power transmitter device.

An operating system program is by a standard procedure transferred to the 4 Kbyte Flash memory of the processor 12 which is provided with an own is clocking arrangement. In a standby state the processor of the low power transmitter is in STOP mode and the device will then only consume a few microamperes. Waking up the processor 12 from this mode is done by a signal on its interrupt request input (IRQ). The activation key S2 is connected to this IRQ input of the processor 12. Pressing the key S2 the processor will advance from the STOP instruction and start to execute its control program. The switch S1 being a semiconductor switch is activated via a Port A and then supplies driving current to circuits 10 and 18. The transmitter circuit 10 then via programming lines DATA/LE/CLK is programmed to the transmit frequency.

After the programming of the transmit frequency, a program loop is executed where the second RIC together with data in the proper format from a Port B is continuously transmitted during a predefined minimum time to the TPLL modulation input of the device 10. As long as Port A is active the low power transmitter will be operating. An optional light-emitting diode (not shown) is activated during transmission to indicate the active transmitter.

This transmission will immediately be received by the transponders within the coverage of the autonomous low power transmitter. Transponders of suitcases or other protected items not being subject for the robbery, but have become activated, can then simply be addressed via the paging system using the first RIC and can thereby be reset to their standby state. Such a measure could then also be taken using a fourth common RIC if available. Such a further embodiment would preferably contain a switch to be unlocked for enabling the command by means of the fourth RIC to the local transponders.

In a second embodiment of the autonomous low power transmitter according to FIG. 1 it will utilize a third global RIC common for the current anti-theft transponders. This type of low power transmitter device is supposed become hidden close to the items protected by the anti-theft transponder system, for instance in a vehicle transporting suitcases with money.

The transponders, for instance of the C-TRACK system mentioned, then are in their software provided with still an additional program module, which can be activated and deactivated by means of commands via the individual first RIC of each transponder. In a typical embodiment this additional program module is upon activation initiating a timer to preset a time when the transponder is starting to at regular intervals expect signals from the transmitter of the second embodiment using the third global RIC. In a preferred embodiment the transponder will confirm this mode of operation by means of a SMS message as described above.

When the second embodiment of the autonomous low power transmitter is active it will repeatedly transmit using the third RIC, which when received by the transponder will make the processor of the transponder restart a timer waiting for a next transmission, for instance within two to five minutes. These short transmissions are like mentioned before repeated a number of times to make certain that the transmissions does not collide with a regular transmission on the paging frequency by the main paging system which still may present an even stronger signal.

If no further control signal with the third RIC is detected this will be interpreted as an abnormal situation and the transponder will be activated in the same way like in the first embodiment when the manual switch of the low power transmitter is activated.

The general function of the second embodiment of the autonomous low power transmitter of the anti-theft system is to take care of a situation when a security officer is taken by surprise and prevented from trigging his low power transmitter using the second RIC. As soon as a robber brings the items protected by the anti-theft transponders away from for instance a vehicle the transponder will lose contact and can no longer receive signaling using the third RIC, and the transponder or transponders will immediately when next expected signal is lost activate the transponder as described.

When the transport has reached its destination the anti-theft transponders can via the paging system using the first RIC be reset to its basic operation mode which stops the execution of the additional program module.

It will be understood by those skilled in the art that various modifications and changes may be made to the present invention without departure from the scope thereof, which is defined by the appended claims.

1. A system for anti-theft transponders, characterized by
an autonomous low power transmitter device capable of transmitting a specified command for accessing at least one anti-theft transponder, the anti-theft transponder comprising one receiver module operating on a designated frequency used by a general coverage paging system, the transponder further comprising at least one transmitting means and control circuitry, and
that the anti-theft transponders are provided with a first individual access identity code for authorization of an activation by means of a paging system and at least a second general access identity code for a direct control by the autonomous low power transmitter within its limited coverage.

2. The system according to claim 1, characterized in that
the autonomous low power transmitter by means of a manual activating switch (S2) initiates a transmitting of a defined series of transmissions of an authorization code for the at least second general access identity code of transponders in the anti-theft transponder system to thereby control each transponder receiving the transmissions of the autonomous low power transmitter.

3. The system according to claim 2, characterized in that
the autonomous low power transmitter utilizes a common signal format, e.g a POCSAG code or similar, to produce the at least second general access identity code for the autonomous low power transmitter for control of each anti-theft transponder within a limited coverage of the autonomous low power transmitter when the autonomous low power transmitter is trigged to operate.

4. A transmitter for anti-theft transponders for locally controlling the anti-transponders for a change into an active mode, characterized in
an autonomous low power transmitter device is formed capable of generating a specified command for accessing at least one anti-theft of the transponders, the anti-theft transponders comprising a receiver module operating on a designated frequency used by a general coverage paging system, and the anti-theft transponders are provided with a first individual access identity code for authorization of an activation by means of a paging system and at least a second general access identity code for a direct control by the autonomous low power transmitter within its limited coverage area, and
that the autonomous low power transmitter is provided with a control switch (S2) for activating a broadcast of a defined series of transmissions with an authorization code for anti-theft transponders in a transponder system to thereby locally control each transponder receiving the transmissions of the autonomous low power transmitter.

5. The transmitter device according to claim 4, characterized in that
the defined series of transmission has a repetition rate during a predetermined time period after initialization in order to guarantee a proper interlacing of transmissions by a general coverage paging system normally controlling activation of the transponder.

6. The transmitter device according to claim 5, characterized in that
the autonomous low power transmitter transmits an authorization code being common for all transponders in an anti-theft transponder system to control all transponders within the coverage area of the low power transmitter.

7. The transmitter device according to claim 6, characterized in that
a transmit frequency of the autonomous low power transmitter is the same as a communication frequency used for a paging system utilized for controlling the transponders of an anti-theft system.

8. The transmitter device according to claim 7, characterized in that
the autonomous low power transmitter utilizes a POCSAG code or any corresponding protocol for transferring at least one general Receiver Identification Code, RIC, to transponders within the limited coverage area of the transmitter to thereby control the transponders receiving signals from the autonomous low power transmitter when it is initialized.

9. The transmitter device according to claim 8, characterized in that
the microprocessor (12) of the autonomous low power is provided with a fourth general RIC which can be transmitted in order to reset local transponders of the anti-theft system to a standby state.
